(19) United States
(12) Patent Application Publication
(10) Pub. No.: US 2014/0159858 A1
(43) Pub. Date: Jun. 12, 2014

(54) Wireless Time and Attendance System

(71) Applicants: James S. Bianco, Suffield, CT (US); William G. Lucas, JR., Suffield, CT (US)

(72) Inventors: James S. Bianco, Suffield, CT (US); William G. Lucas, JR., Suffield, CT (US)

(21) Appl. No.: 14/102,826

(22) Filed: Dec. 11, 2013

Related U.S. Application Data
(60) Provisional application No. 61/735,762, filed on Dec. 11, 2012.

(51) Int. Cl. G07C 9/00

(52) U.S. Cl. CPC G07C 9/00007
USPC 340/5.6; 340/6.1

(57) ABSTRACT

A wireless time and attendance system automatically collects data to compile attendance of various individuals at separate spaces within a facility for various time intervals. A coordinator terminal employs an integrated reader, a touchpad, a time display and a communication link which communicates with a host computer and a wireless communication module. Multiple point-of-entry/exit (“POE”) terminals are connected to the coordinator terminal via wireless communication links. Each of the POE terminals comprises an integrated ID input and an attendance indicator input. Time and attendance data entered on the POE terminals is compiled for transmission to the host computer. In one embodiment, a ZigBee wireless mesh network is employed.

### BACKGROUND

This disclosure relates generally to systems and methods for recording time and attendance. More particularly, this disclosure relates generally to electronic systems that automatically monitor and record attendance.

### SUMMARY

Briefly stated, a wireless time and attendance (“T&A”) system comprises a coordinator terminal having an integrated reader, a touchpad, a time display, at least one communication link for communicating with a host computer and an RF communication module. Multiple point-of-entry/exit (“POE”) terminals connect to the coordinator terminal by RF communication links. Each POE terminals comprises an integrated user ID input and an attendance indicator input. Data of time and attendance entered on the POE terminals is compiled for transmission to the host computer.

The POE terminals are preferably connected by a ZigBee mesh network. Each of the POE terminals is operated on low power. The POE terminals may comprise a card reader, a bio-reader and/or a touchscreen input. The POE terminals employ a PAN ID which is input via a card or a thumb drive. A controller module communicates with a POE terminal for controlling access to a controlled space.

A method for compiling time and attendance data for a facility having a plurality of locations comprises entering an ID at a coordinator terminal providing access to the facility. The method also comprises entering input data comprising ID, entry and exit inputs at a plurality of POE terminals at each said location and transmitting input data between said POE terminals and said coordinator terminal via RF communication. The method also comprises communicating said input data from said coordinator terminal to a host computer.

The step of entering input data comprises reading a card and/or touching a screen or keypad. The step of transmitting input data comprises transmitting RF communications over a ZigBee wireless mesh. The method also comprises automatically controlling access to a controlled space, such as a classroom, in response to an ID input entered in at least one POE terminal.

A wireless time and attendance system comprises a coordinator terminal having an integrated reader and a touchpad and at least one communication link for communicating with a host computer and a wireless communication module. Multiple point-of-entry/exit (“POE”) router terminals are connected to the coordinator terminal by wireless communication links. Each of the POE terminals has an integrated ID input and an attendance indicator input. A controller module communicates with at least one POE terminal to automatically provide access to a controlled space. Data of time and attendance entered on said POE terminals is compiled for transmission to the host computer.

The terminals are preferably connected by a ZigBee mesh network. The POE terminals are operated on low power and comprise a touchpad. Each of the POE terminals has a port for inputting a PAN ID via a card or a thumb drive.

### BRIEF DESCRIPTION OF THE DRAWINGS

FIG. 1 is an annotated block diagram of a wireless time and attendance (“T&A”) system;

FIG. 2 is an annotated block diagram of a coordinator terminal for the T&A system of FIG. 1;

FIG. 3 is an annotated block diagram for a POE terminal for the T&A system of FIG. 1;

FIG. 4 is an annotated block diagram of a range extender router for the T&A system of FIG. 1;

FIG. 5 is an annotated block diagram of a wireless T&A system for a gateway;

FIG. 6 is an annotated block diagram of a gateway coordinator computer for the system of FIG. 5;

FIG. 7 is a front elevational view of a POE terminal for the T&A system of FIGS. 1; and

FIG. 8 is a side elevational view of the POE terminal of FIG. 7.

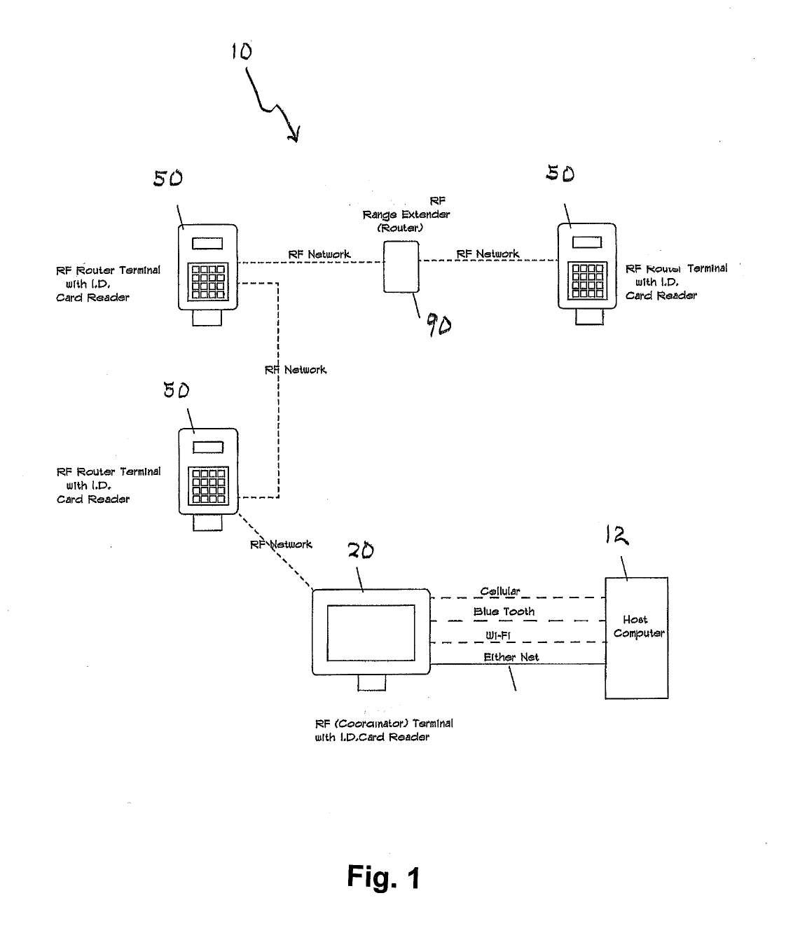

### DETAILED DESCRIPTION

With reference to the drawings, wherein like numerals represent like parts throughout the figures, a wireless time and attendance (“T&A”) system is generally designated by the numeral 10. The wireless time and attendance system 10 is particularly adapted to automatically collect data to compile the attendance of various individuals at separate controlled enclosures, spaces or areas (“controlled spaces”) within a facility for various time intervals throughout a session or extended time period. The wireless T&A system 10 has particular applicability in connection with monitoring the attendance of students within multiple classrooms of a school or building throughout the day or over an extended date range and for automatically compiling data for attendance records and transmitting data to a central host computer 12. The wireless T&A system 10 is an efficient modular system which is easily installed and operates on low power.

The wireless T&A system 10 employs a management or coordinator terminal 20 which communicates via radio frequency (“RF”) directly or indirectly with a plurality of point-of-entry/exit (“POE”) router terminals 50. The coordinator terminal 20 is a low power device preferably located at the entrance/exit of the facility. The POE router terminals 50 are located at each entrance/exit of a location, such as a classroom, within the facility. The POE terminals 50 also operate on low power, for example, 12, 18 or 24 volts DC or 120 volts AC.

Each of the terminals is mounted for easy access and input by numerous users. The communication between the various terminals is preferably accomplished by a ZigBee mesh network so that the system can be installed, replaced, modified and/or expanded if necessary, without extensive hard wiring between the various terminals. The wireless T&A system 10 is highly flexible and easily adapted to a wide range of applications. For some embodiments, WI-FI communication may be employed.

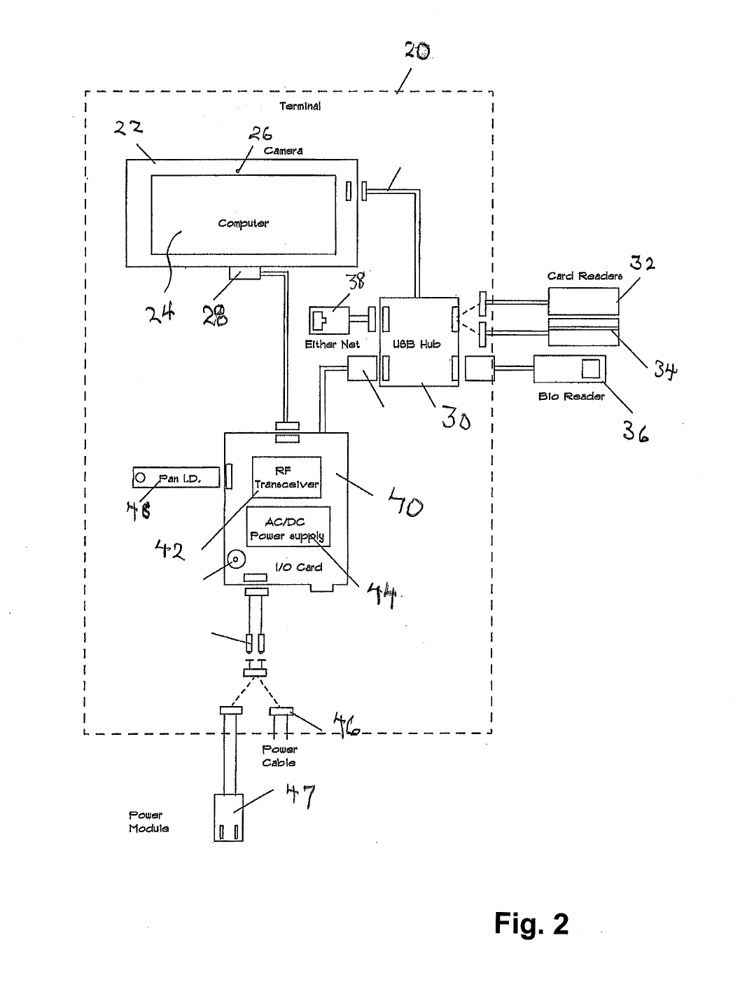

With additional reference to FIG. 2, the coordinator terminal 20 includes a computer 22 with a touchscreen 24. The terminal 20 also has a camera 26. A USB hub 30 functions as a communication center for the computer 22. The individual user enters an ID which can be entered by means of a card reader, a fingerprint or biometric identification, proximity sensor or a full identification. The screen 24 also prominently displays the time and the date and provides an “in” and “out” touchpad as well as numerous other touchpad choices. For some embodiments, the terminal may also include a microphone and a speaker to allow for voice communication with a remote terminal. The hub 30 connects with a barcode reader 32, a magnetic card reader 34 and/or a bio-reader 36. Preferably, the reader ports include barcode, magnetic, proximity, smart code and biometric capabilities. The USB hub 30 also bi-directionally communicates with the Ethernet 38.

An input/output card 40 includes an RF transceiver 42 powered by an AC/DC power supply 44. The input/output card 40 connects with an I/O port 28 of the computer 22 and with the hub 30. Power is supplied to the power supply 44 via a power cable 46 or a power module 47. The PAN ID, which may be placed on a card or a thumb drive, is input into the input/output card via socket 48.

The coordinator terminal 20 also preferably includes the capability of validating an input and allowing access through a controlled door, gate or other barrier to the facility. The terminal is capable of communicating via numerous links, such as WI-FI, Bluetooth and cellular. In one preferred application, the coordinator terminal 20 communicates via WI-FI with the host computer 12 and also communicates via the Ethernet with the host.

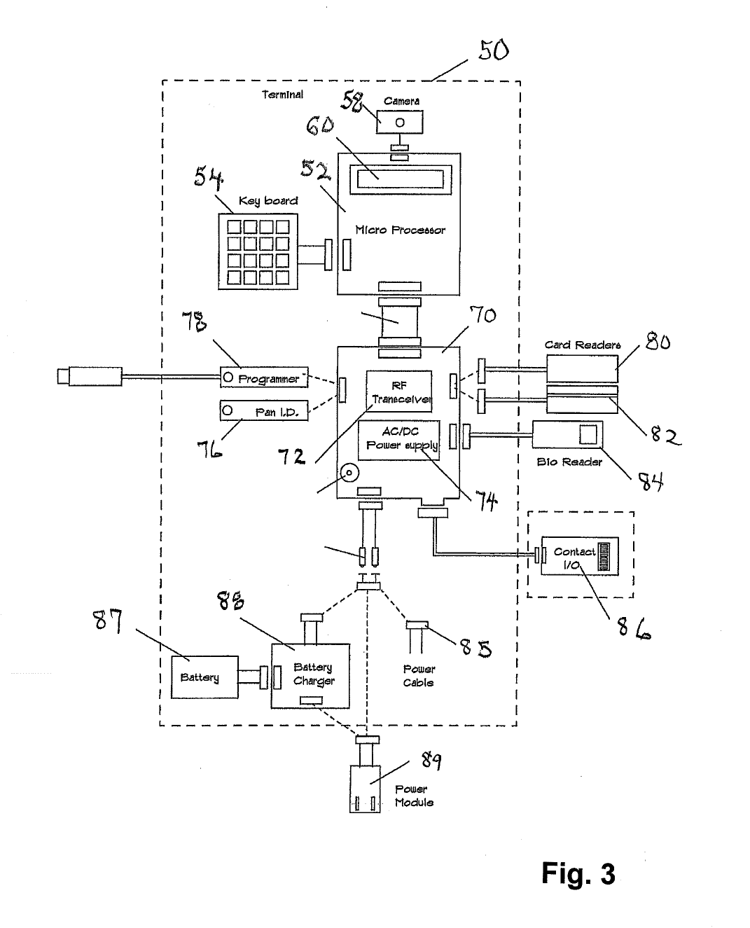

With additional reference to FIG. 3, each POE terminal 50 has a microprocessor 52 which receives input from a keypad 54 and communicates with a screen 60. The screen 60 functions to display the time and date and as various directions and information for inputting “in” and “out” or “entry” and “exit” designations (“attendance indicators”). The microprocessor is also capable of receiving input from a camera 58.

The POE terminal 50 employs ZigBee communication components and codes to connect the POE terminal 50 to the coordinator terminal 20 and/or to connect the terminal with other terminals 50. For one embodiment, the ZigBee function is provided by an XB Pro module of Digi Industrial, Inc., of Minnetonka, Minn..

An input/output card 70 includes an RF transceiver 72 powered by an AC/DC power supply 74. The card 70 receives input from a proximity card reader, 80 a magnetic strip reader 82 or a bio-reader 84, and communicates with a contact input/output isolation relay 86 which controls the operation of a door locking strike or a door latch to provide controlled access from the exterior to a classroom or a controlled space. The students, for example, can use their cards, a PIN or a fingerprint to provide identification and then use the keypad or screen to indicate whether they are entering or leaving a location. In preferred embodiments, the POE terminal 50 is mounted adjacent the entrance to each controlled space to control access through the door of a classroom or other location.

The low power for the terminal 50 may be supplied from either a power cable 85, or a battery power supply 87 or a power module 89. The terminal preferably includes a battery charger 88. The network address and programming for each POE terminal 50 is input through a PAN ID which is placed on a card or a thumb drive 76 or a programmer connector 78 which plugs to the input/output card 70.

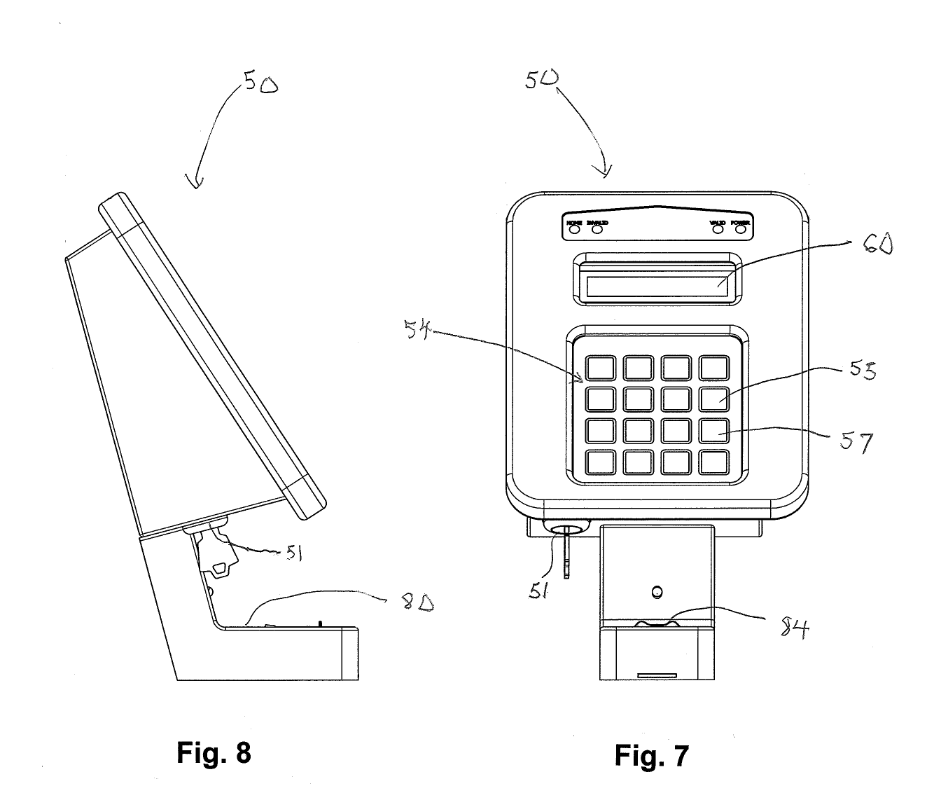

With reference to FIGS. 7 and 8, the POE terminal 50, in one embodiment, has a compact low power form which includes a keypad 54 having a matrix of keys 5 including a dedicated key 55 for “in” or “entry” and a dedicated key 57 for “out” or “exit”. The keypad may also be employed to enter an ID code for identifying the user. In addition, a screen 60 indicates the time and date and/or provides other information. The terminal 50 may also include a barcode/magnetic reader 80 and a biometric or fingerprint reader 84. In one embodiment, the terminal operates on 110 VAC and/or an 18 volt current power pack (not illustrated). In the latter embodiment, the terminal 50 is mounted to a wall and a power pack is plugged in to provide the requisite power. It should be appreciated that for terminal embodiments that incorporate the ZigBee wireless function, multiple terminals may be effectively employed in a mesh network under the same roof or within one mile line of site. In one embodiment, the keypad has a multi-function membrane configuration. The dimensions of the terminal without the wall mount bracket are approximately 6 inches×7 inches×3.5 inches. A key operated security control switch 51 is provided. The POE terminal 50 may optionally employ a camera and a proximity sensor.

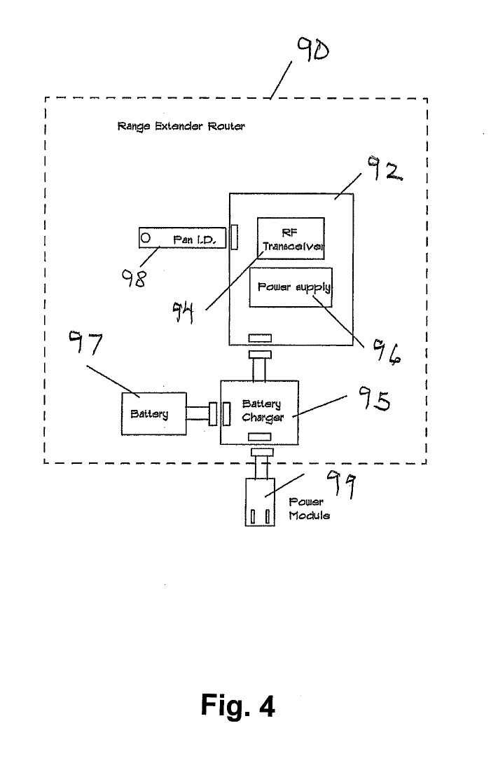

In order to provide additional range for the wireless T&A system, a range extender router 90, such as illustrated in FIG. 4, is employed. The input/output card 92 has an RF transceiver 94 and a power supply 96. The power supply 96 connects via a battery charger 95 for a battery power supply 97 or a power module 99. A PAN ID on a thumb drive 98 or a card or a programmer connector provides address/routing codes to the input/output card 92. The RF transceiver 94 communicates with various POE terminals as required.

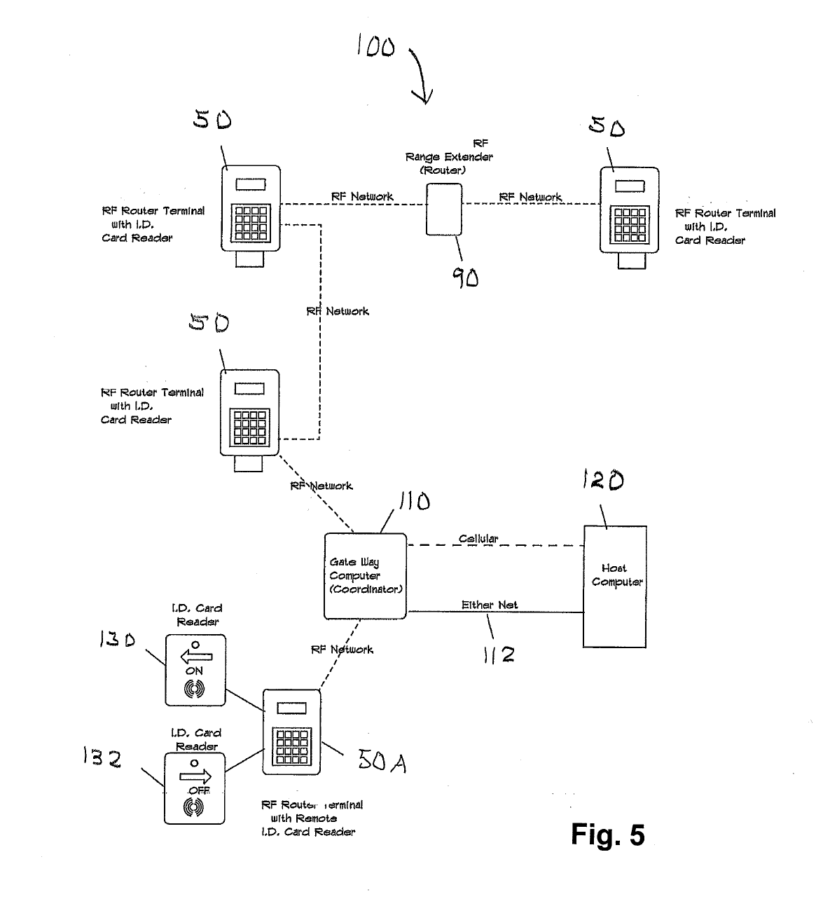

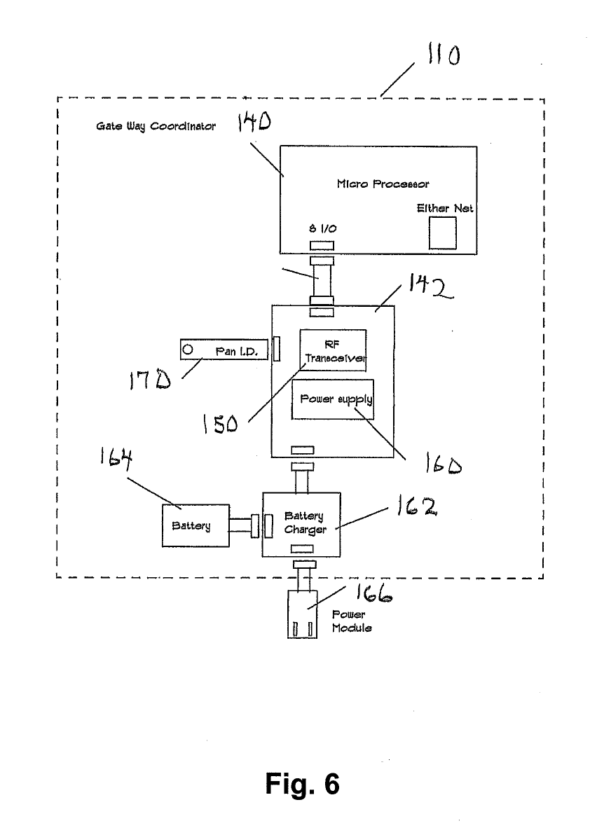

With reference to FIGS. 5 and 6, the T&A network system may also be employed in the context of a gateway system 100 which securely controls access to numerous locations within a facility. A gateway coordinator computer 110 communicates via cellular link or an Ethernet link 112 with a host computer 120. The gateway computer 110 also communicates via an RF network with multiple RF terminals 50. The gateway computer 110 also communicates over an RF network with a router terminal 50A having an ID card reader 130 for turning the system on or an ID card reader 132 for turning the system off. The computer also communicates with multiple RF router terminals 50 with an ID card reader via an RF network as previously described. An RF range extender router 90 can also be employed to extend the range of the RF network.

With reference to FIG. 6, the gateway coordinator computer 110 comprises a microprocessor 140 which has an Ethernet port 142. The microprocessor 140 communicates with an input/output card 144 having an RF transceiver 150 and a power supply 160 which operates on low power. The power supply 160 connects via a battery charger 162 with a battery 164 or a power module 166. The PAN ID 170 for the RF transceiver is placed on a thumb drive or card and connected to the input/output card 142 to provide the routing for the various RF communications.

It will be appreciated that the network of POE router terminals 50 can be installed at locations spaced at relatively large distances within a facility. The ZigBee mesh network will allow for such relatively large distances without hard wiring between the various terminals. A high degree of flexibility and modularity is accomplished by efficient programming of the terminals. Each ZigBee module within the POE unit has a unique address. Each terminal has a unique PAN ID that identifies all of the nodes for which each of the ZigBee modules communicates. A thumb drive or card containing the PAN ID or other input devices may be employed for ready incorporation of the appropriate PAN ID into each of the terminals 20, 50 and 110.

While the foregoing embodiments of a wireless time and attendance system have been set forth for purposes of illustration, the foregoing should not be deemed a limitation of the invention herein. Accordingly, various modifications, adaptations and alternatives may occur to one skilled in the art without departing from the spirit and the scope of the present invention.

1. A wireless time and attendance system comprising:
a coordinator terminal having an integrated reader, a touchpad, a time display, at least one communication link for communicating with a host computer and an RF communication module;
a plurality of point-of-entry/exit (POE) terminals connected to said coordinator terminal by RF communication links, each said POE terminal comprising an integrated ID input and an attendance indicator input;
wherein data of time and attendance entered on said POE terminals is compiled for transmission to said host.

2. The wireless system of claim 1 wherein said POE terminals are connected by a ZigBee mesh network.

3. The wireless system of claim 1 wherein each of said POE terminals is operated on low power.

4. The wireless system of claim 1 wherein each of said POE terminals comprises a card reader.

5. The wireless system of claim 1 wherein each of said POE terminals comprises a bio-reader.

6. The wireless system of claim 1 wherein each of said terminals has a PAN ID input via a card or thumb drive.

7. The wireless system of claim 1 wherein each of said POE terminals comprises a touchpad input.

8. The wireless system of claim 1 further comprising a module communicating with a said POE terminal for controlling access to a controlled space.

9. A method for compiling time and attendance data for a facility having a plurality of locations comprising:
entering an ID at a coordinator terminal providing access to said facility;
entering an input data comprising ID and entry and exit inputs at a plurality of POE terminals at each of said locations;
transmitting input data between said POE terminals and said coordinator terminal via RF communication; and
communicating said input data from said coordinator terminal to a host computer.

10. The method of claim 9 wherein the step of entering input data comprises reading a card.

11. The method of claim 9 wherein the step of entering input data comprises touching a screen or keypad.

12. The method of claim 9 wherein the step of transmitting input data comprises transmitting over a ZigBee mesh network.

13. The method of claim 9 further comprising automatically controlling access to a controlled space in response to an ID input at least one POE terminal.

14. A wireless time and attendance system comprising:
a coordinator terminal having an integrated reader and a touch input function, at least one communication link for communicating with a host computer and a wireless communication module;
a plurality of point-of-entry/exit (POE) router terminals connected to said coordinator terminal by wireless communication links, each said POE terminal comprising an integrated ID input and an attendance indicator input;
a controller module communicating with at least one POE terminal to automatically provide access to a controlled space;
wherein data of time and attendance entered on said POE terminals is compiled for transmission to said host.

15. The wireless system of claim 14 wherein said terminals are connected by a ZigBee mesh network.

16. The wireless system of claim 14 wherein each of said POE terminals is operated on low power.

17. The wireless system of claim 14 wherein each of said POE terminals comprises a card reader.

18. The wireless system of claim 14 wherein each of said POE terminals comprises a bio-reader.

19. The wireless system of claim 14 wherein each of said POE terminals has a port to receive a PAN ID input via a card or a thumb drive.

20. The wireless system of claim 14 wherein each of said POE terminals has a keypad.
